(19) United States
(12) Patent Application Publication
(10) Pub. No.: US 2025/0216001 A1
(43) Pub. Date: Jul. 3, 2025

(54) VALVE WITH DUAL BALL VALVES

(71) Applicant: Kres(Suzhou) Power Systems Technology Co., Ltd, Suzhou (CN)

(72) Inventor: Jiaxin Wan, Jingdezhen (CN)

(21) Appl. No.: 19/086,178

(22) Filed: Mar. 21, 2025

(51) Int. Cl. F16K 35/02; F16K 5/06; F16L 37/248; F16L 37/373

(52) U.S. Cl. CPC F16K 35/025; F16K 5/0647; F16L 37/248; F16L 37/373

(57) ABSTRACT

The present disclosure discloses a valve with dual ball valves, including two ball valves arranged side by side and clamped with each other, wherein each ball valve includes a valve body, a ball body, a valve rod and a handle, clamping structures are respectively and correspondingly arranged on one surfaces of the two valve bodies abutting against each other, and each ball valve further includes a limiting seat, a first anti-misoperation device and a second anti-misoperation device. The first anti-misoperation devices ensure that the handles can be rotated freely only when the two ball valves are in a clamped state. The second anti-misoperation devices ensure that the handles can only be rotated when external force is applied to the handles. Misoperation on the valve is prevented through triple protection.

### TECHNICAL FIELD

The present disclosure relates to the technical field of valves, in particular to a valve with dual ball valves.

### BACKGROUND OF THE INVENTION

A valve with dual ball valves is used by combining the two ball valves together. When a pipeline connected with one ball valve has faults and needs to be removed or repaired, the other ball valve is closed, and the faulty ball valve and pipeline are removed and repaired, thereby omitting the work of leaking stoppage, and facilitating use. For quick assembly between the two ball valves, the two ball valves are often clamped together. According to an existing clamping connection form, a clamping groove is formed in one end of one ball valve, the clamping groove is formed around a fluid channel in the ball valve, a clamping buckle is arranged at one end of the other ball valve, and the clamping buckle is inserted from an opening of the clamping groove and rotates to complete the clamping connection. After the clamping connection is completed, the two ball valves are rotated to be in an open state. However, the existing valve with the dual ball valves has a low safety coefficient and lacks an anti-removing device. When the two ball valves are in the open state, separating the two ball valves may cause fluid leakage.

### SUMMARY OF THE INVENTION

To overcome the above disadvantages, the objective of the present disclosure is to provide a valve with dual ball valves, and misoperation on the valve is prevented through triple protection.

In order to achieve the above objective, the technical solution used in the present disclosure is that a valve with dual ball valves includes two ball valves arranged side by side and clamped with each other, wherein each ball valve includes a valve body, a ball body, a valve rod and a handle, clamping structures are respectively and correspondingly arranged on one surfaces of the two valve bodies abutting against each other, and each ball valve further includes a limiting seat and a first anti-misoperation device. The limiting seats are arranged at one ends of the valve bodies provided with the clamping structures, the limiting seats extend outward along outer walls of the valve bodies, the limiting seats are of a polygonal structure, and when the two valve bodies are clamped, the two limiting seats abut against each other, and projection surfaces of the two limiting seats in a flowing direction of fluid overlap; and when the ball valves are in an open state, the handle is located on one side of one edge of the limiting seat of the ball valve and extends to the same side of a corresponding edge of the limiting seat of the other ball valve, and the handle limits rotation of the two limiting seats. The first anti-misoperation devices can lock one ball valve in a closed state when one ball valve is separated from the other ball valve, each first anti-misoperation device includes a first locking device and a first positioning groove, the first locking devices are arranged on the valve bodies, the first positioning grooves are formed in the handles, and when the handles rotate to be in a state where the ball valves are closed, the first locking devices can be clamped into the first positioning grooves.

The present disclosure has the beneficial effects that the limiting seats are arranged to be of the polygonal structure, and cooperate with the handles to ensure that when the two ball valves are clamped and are in the open state, the handles rotate to the same side of the corresponding edges of the limiting seats of the two ball valves, which plays a role in limiting the limiting seats of the polygonal structure and prevents the ball valves from rotating (the handles are touched when rotating the limiting seats). Meanwhile, by cooperating with the first anti-misoperation devices, it is ensured that the handles may be rotated freely only when the two ball valves are in a clamped state. When two ball valves are separated, that is, one end of a single ball valve is a free end, the first anti-misoperation devices will limit the handles to be in a state where the ball valves are closed, thereby reducing misoperation on the ball valves when the ball valves are not properly connected.

Further, when the ball valves are in the open state, a distance between the handles and the limiting seats in a vertical direction is less than 5 mm. The small distance ensures a limiting effect of the handles on the limiting seats. The smaller the distance here, the better the limiting effect of the handles on the limiting seats, which can reduce the rotation of the limiting seats, namely, the valve bodies.

Further, the polygonal structure is a quadrangle, and chamfers are arranged between two adjacent edges of the quadrangle. The quadrangle is easy to be in butt joint and process, and the polygonal structure may also be a pentagon or a hexagon.

Further, a rotation angle of the handle is 90°, when the handle rotates to a position where a length direction is parallel to the flowing direction of the fluid, the ball valve is open, a projection of the handle in a direction perpendicular to the flowing direction of the fluid partially overlaps with one edge of the limiting seat of the other ball valve, and at this time, the limiting seat is limited. When the handle rotates to a position where the length direction is perpendicular to the flowing direction of the fluid, the ball valve is closed, the projection of the handle in the direction perpendicular to the flowing direction of the fluid is separated from the limiting seat of the other ball valve, that is, the projection of the handle does not overlap with the limiting seat of the other ball valve at all, which will not cause any interference with the rotation of the limiting seat, and at this time, the ball valve may be disassembled.

Further, the first locking devices include first positioning beads, first positioning pins, and first reset members, the first positioning beads can move back and forth along the valve bodies in a vertical direction, one ends of the first positioning pins extend out of the valve bodies, and the first positioning pins can move back and forth along the ball valves in a horizontal direction. When the ball valves are clamped, the first positioning pins can approach the first reset members under pushing of the other ball valve, and at this time, the first positioning pins can provide a receding space for falling of the first positioning beads; and when the ball valves are separated, the first positioning pins are away from the first reset members under driving of the first reset members, the first positioning pins can push the first positioning beads to move upwards and limit a part of the first positioning beads in the first positioning grooves.

Further, first sliding grooves I for allowing the first positioning pins to slide and second sliding grooves I for allowing the first positioning beads to slide are formed in the valve bodies, the first sliding grooves I and the second sliding grooves I are formed perpendicularly and communicate with each other, one ends of the second sliding grooves I are located in middle positions of the first sliding grooves I, and depths of the second sliding grooves I are smaller than diameters of the first positioning beads. The depths of the second sliding grooves I ensure that when there is no first receding space for communicating with the second sliding grooves I, the first positioning beads inevitably have a part protruding out of the second sliding grooves I, that is, protruding out of the valve bodies.

Further, each first positioning pin includes a first pressing portion, a first receding portion, and a first limiting portion which are connected in sequence, the first limiting portions are connected to the first reset members, and one ends of the first pressing portions extend out of the first sliding grooves I.

Shapes of the first limiting portions match shapes of the first sliding grooves I, and when the first limiting portions move to be under the second sliding grooves I, the first limiting portions close a connection of the second sliding grooves I and the first sliding grooves I; and first receding grooves are formed in outer walls of the first receding portions, and when the first receding grooves move to be under the second sliding grooves I, the first receding grooves communicate with the second sliding grooves I and define a first receding space with the first sliding grooves I.

Further, the first receding grooves are first annular grooves formed along outer walls of the receding portions in a circumferential direction, and openings of the first receding grooves are of a flaring structure. When the first positioning pins are reset, the first positioning beads may slide along an inclined surface of the flaring structure of the first receding grooves, thereby reducing hard contact between the first positioning beads and the first positioning pins, and prolonging the service life of the first positioning beads and the first positioning pins.

Further, the ball valves further include second anti-misoperation devices, the second anti-misoperation devices can lock open and closed states of the ball valves, the second anti-misoperation devices include second locking devices and second positioning grooves, the second locking devices are arranged on the handles and can move synchronously with the handles, the second positioning grooves correspond to the locking devices and are arranged on the valve bodies, two second positioning grooves are provided, and the two second positioning grooves respectively correspond to the open and closed states of the ball valves.

The second locking devices move synchronously with the handles and are arranged on the handles without being lost. Moreover, unlocking may be completed only by pushing with external force, thereby avoiding misoperation on the ball valves caused by a false touch on the handles.

Further, the second locking devices include second positioning beads, second positioning pins, and second reset members, the second positioning beads can move back and forth along the handles in a vertical direction, the second positioning pins can move along the handles in a horizontal direction and reset under pushing of the second reset members, the second positioning pins can approach the second reset members under pushing of external force, at this time, the second positioning pins can provide a second receding space for upward movement of the second positioning beads, and when the second positioning pins are away from the second reset members under driving of the second reset members, the second positioning pins can push the second positioning beads to move downwards and limit a part of the second positioning beads in the second positioning grooves.

When rotating the handles, the second positioning pins mush be pushed through the external force, so as to overcome thrust provided by the second reset members, and make the second positioning pins move to a position where a second receding space is provided for upward movement of the second positioning beads. At this time, the handles are pushed again, and the second positioning grooves can be utilized to move the second positioning beads upwards to slide out of the second positioning grooves, thus unlocking the handles. When the second positioning beads reach the second positioning grooves, the second positioning pins are released through the external force, the second positioning pins are reset under the driving of the second reset members, at this time, the second positioning beads move downwards under gravity and the pushing of the second positioning pins and are partially clamped into the second positioning grooves, and the second positioning pins return to an initial position and limit upward movement of the second positioning beads, thus locking the handles.

Further, guiding assemblies located inside the valve bodies are further arranged at one ends of the ball bodies away from the valve rods; and the guiding assemblies include guiding rods, the guiding rods are coaxially arranged with the valve rods and can move up and down along axes of the guiding rods, guiding grooves arranged corresponding to the guiding rods are formed in the ball valves, and the guiding rods can extend into the guiding grooves under driving of third reset members. The guiding rods are arranged and cooperate with the valve rods to limit the ball valves at upper and lower ends of the ball bodies, thereby improving rotating stability of the ball valves.

### BRIEF DESCRIPTION OF DRAWINGS

FIG. 1 is a schematic structural diagram of an embodiment of the present disclosure in an open state.

FIG. 2 is a stereo view of a ball valve in an embodiment of the present disclosure.

FIG. 3 is a top view of a ball valve of an embodiment of the present disclosure in a closed state.

FIG. 4 is a sectional view along a line A-A in FIG. 3.

FIG. 5 is an enlarged view of a position A in FIG. 4.

FIG. 6 is a top view of a ball valve of an embodiment of the present disclosure in an open state.

FIG. 7 is a sectional view along a line B-B in FIG. 6.

FIG. 8 is an enlarged view of a position B in FIG. 7.

FIG. 9 is a side view of a ball valve in an embodiment of the present disclosure.

FIG. 10 is a schematic diagram of a stereo structure of a valve body in an embodiment of the present disclosure.

FIG. 11 is a schematic structural diagram of a first positioning pin in an embodiment of the present disclosure.

FIG. 12 is a schematic structural diagram of a handle in an embodiment of the present disclosure.

FIG. 13 is a sectional view along a line C-C in FIG. 3.

FIG. 14 is an enlarged view of a position C in FIG. 13.

In the figures:

1. Valve body; 11. Clamping buckle; 12. First sliding groove I; 13. Second sliding groove I; 14. Fluid channel; 2. Ball body; 3. Valve rod; 4. Handle; 41. First sliding groove II; 42. Second sliding groove II; 5. Joint pipe; 6. Limiting seat; 7. First anti-misoperation device; 71. First positioning bead; 72. First positioning pin; 721. First pressing portion; 722. First receding portion; 7221. First receding groove; 723. First limiting portion; 73. First reset member; 74. First positioning groove; 8. Second anti-misoperation device; 81. Second positioning bead; 82. Second positioning pin; 821. Second receding groove; 83. Second reset member; 84. Second positioning groove; 91. Guiding rod; 92. Guiding groove; 93. Third reset member; 94. Placement groove.

### DETAILED DESCRIPTION OF THE INVENTION

Preferred embodiments of the present disclosure are described in detail below in combination with accompanying drawings, so that advantages and features of the present disclosure can be more easily understood by those skilled in the art, and a protection scope of the present disclosure can be more clearly defined.

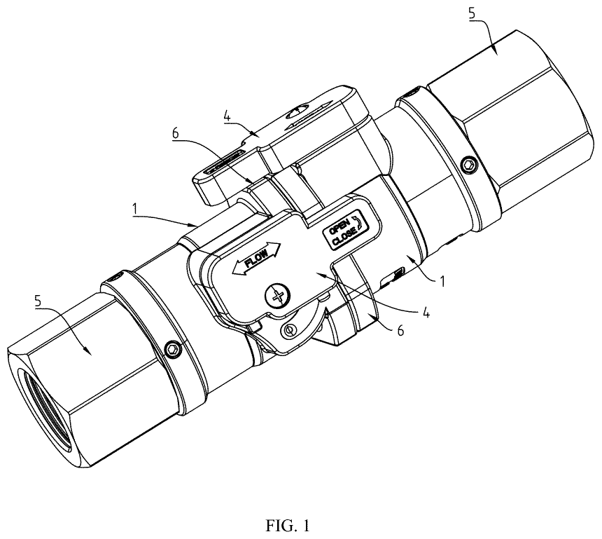

As shown in FIG. 1, a valve body 1 with dual ball valves includes two ball valves arranged side by side, and the two ball valves are clamped. Clamping structures are respectively and correspondingly arranged on one surfaces of the two ball valves abutting against each other, the clamping structures include clamping grooves and clamping buckles 11, and when the clamping buckles 11 are clamped into the clamping grooves, the two ball valves are fixed. One ball valve is rotated to clamp the clamping buckle 11 into the clamping groove of the other ball valve.

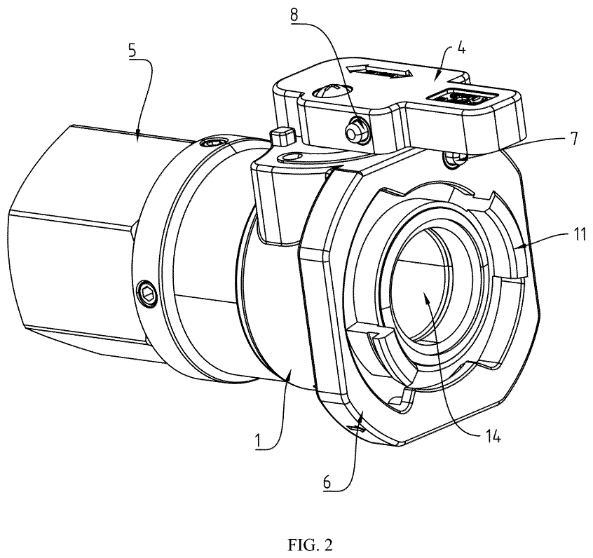

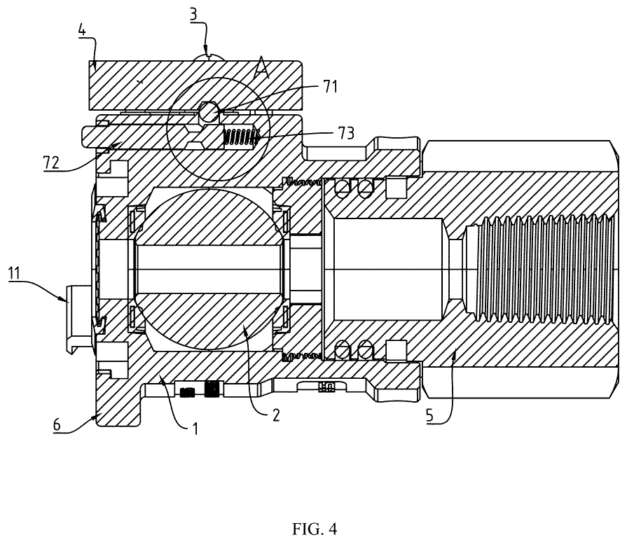

As shown in FIG. 2 and FIG. 4, the ball valves have the same structure and each includes a valve body 1, a ball body 2, a valve rod 3, and a handle 4. The valve bodies 1 are provided with fluid channels 14 in an axial direction of the valve bodies. The ball bodies 2 are rotatably connected into the fluid channels 14 and open or close the fluid channels 14 in the rotation process. The valve rods 3 are fixed to the ball bodies 2, one ends of the valve rods 3 are fixedly connected with the ball bodies 2, and the other ends of the valve rods penetrate through the valve bodies 1 to be connected with the handles 4.

The clamping grooves and the clamping buckles 11 are arranged at ends of the valve bodies 1, the ball bodies 2 are rotatably connected in the fluid channels 14, and in a rotation process, the ball bodies 2 can control opening and closing of the fluid channels 14, that is, opening and closing of the ball valves. The valve rods 3 and the fluid channels 14 are arranged perpendicularly, one ends of the valve rods 3 are fixed to the ball bodies 2, and the other ends of the valve rods penetrate through the valve bodies 1 to be fixedly connected with the handles 4.

The clamping buckles 11 are arranged on one sides of the valve bodies 1, the plurality of clamping buckles are distributed at intervals around the fluid channels 14, and the clamping buckles 11 are arranged annularly. The clamping buckles 11 are of an L-shaped structure and include connecting portions and clamping portions, and the connecting portions are parallel to the fluid channels 14. The clamping grooves are formed in the connecting portions, and the clamping portions are clamped into the clamping grooves. When the two ball valves are connected, the clamping buckles 11 of one ball valve are inserted between the two adjacent clamping buckles 11 of the other ball valve, and then one ball valve is rotated to achieve the clamping connection of the two ball valves.

Sealing rings arranged around the fluid channels 14 are further embedded at one ends of the valve bodies 1 provided with the clamping buckles 11. When the two valve bodies 1 are clamped, the sealing rings are extruded and deformed, so as to play a sealing effect on a connection of the two valve bodies 1.

The ball valves further include joint pipes 5, the joint pipes 5 are located at one ends of the valve bodies 1 away from the clamping buckles 11, and the joint pipes 5 are inserted into the valve bodies 1 and can rotate along its own axes. Internal threads are arranged on inner walls of the joint pipes 5, and the joint pipes 5 can be quickly connected to an external pipeline. Sealing rings are arranged between the joint pipes 5 and the valve bodies 1 to improve sealing performance.

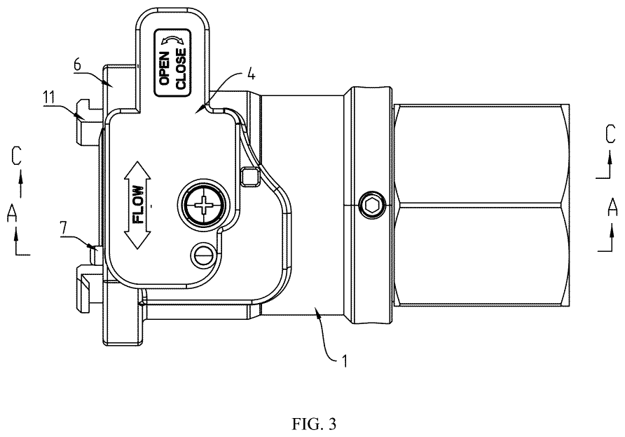

As shown in FIG. 1 and FIG. 2, limiting seats 6 of a polygonal structure are arranged at one ends of the ball valves provided with the clamping buckles 11, and the limiting seats 6 extend outwards along outer walls of the valve bodies 1. When the two ball valves are clamped, the two limiting seats 6 abut against each other, and projection surfaces in a flowing direction of fluid completely overlap. When the ball valve is in an open state, the handle 4 is located on one side of one edge of the limiting seat 6 of the ball valve, and extends to the same side of a corresponding edge of the limiting seat 6 of the other ball valve. That is, the handles 4 are arranged on the same sides of the corresponding edges of the limiting seats 6 of the two ball valves. The handles 4 can partially cover one edges of the limiting seats 6, and the handles 4 extend in the flowing direction of the fluid in a circulation channel. When the ball valves are in a closed state, as shown in FIG. 3, the handles 4 are perpendicular to the flowing direction of the fluid in the circulation channel. At this time, the handles 4 will not cover the limiting seat 6 of the other ball valve, and will not interfere with the rotation and clamping of the two ball valves.

A fixing point of the handles 4 and the valve rods 3 is located on one sides of the limiting seats 6 in the flowing direction of the fluid, so that in a rotation process of the handles 4, the handles 4 rotate with the fixing point as a central point.

When the ball valves are opened, a distance between the handles 4 and the limiting seats 6 in a vertical direction is less than 5 mm, where the vertical direction is a direction perpendicular to the flowing direction of the fluid. Due to the polygonal structure of the limiting seats 6 and the limiting of the handles 4, the two ball valves cannot rotate therebetween, thereby avoiding separation of the ball valves in the open state of any ball valve and effectively reducing fluid leakage. The smaller the distance here, the better the limiting effect of the handles on the limiting seats, which can reduce the rotation of the limiting seats, namely, the valve bodies.

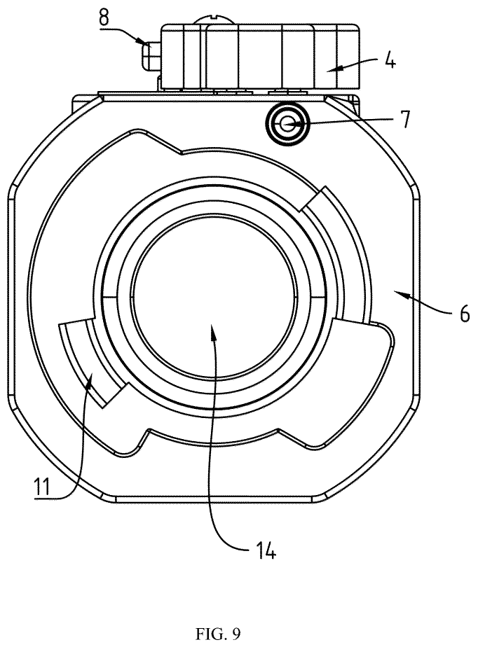

As shown in FIG. 2 and FIG. 9, in the present embodiment, the polygonal structure is a quadrangle, and chamfers are arranged between two adjacent edges. The polygonal structure may also be a pentagon or a hexagon, and edges of the polygonal structure are limited by using the handles 4, which avoids the rotation of the two ball valves and improves the safety of the ball valves.

Rotation angles of the handles 4 are 90°, when the handles 4 rotate to a position where length directions are parallel to axis directions of the fluid channels 14, the ball valves are open, and at this time, projections of the handles 4 in a direction perpendicular to the flowing direction of the fluid partially overlap with one edges of the limiting seats 6; and when the handles 4 rotate to a position where the length directions are perpendicular to the axis directions of the fluid channels 14, the ball valves are closed, and at this time, the projections of the handles 4 in the direction perpendicular to the flowing direction of the fluid do not overlap with one edges of the limiting seats 6 at all.

As shown in FIG. 2, first anti-misoperation devices 7 are further arranged on the ball valves, and the first anti-misoperation devices 7 can ensure that the handles 4 can be rotated to be in a state where the ball valves are open only when the two ball valves are in a clamped state. When the two ball valves are not connected and separated, the handles 4 can only be located in a position where the ball valves are closed, and the ball valves cannot be rotated to be opened. The first anti-misoperation devices 7 lock the ball valves in a fully-closed state.

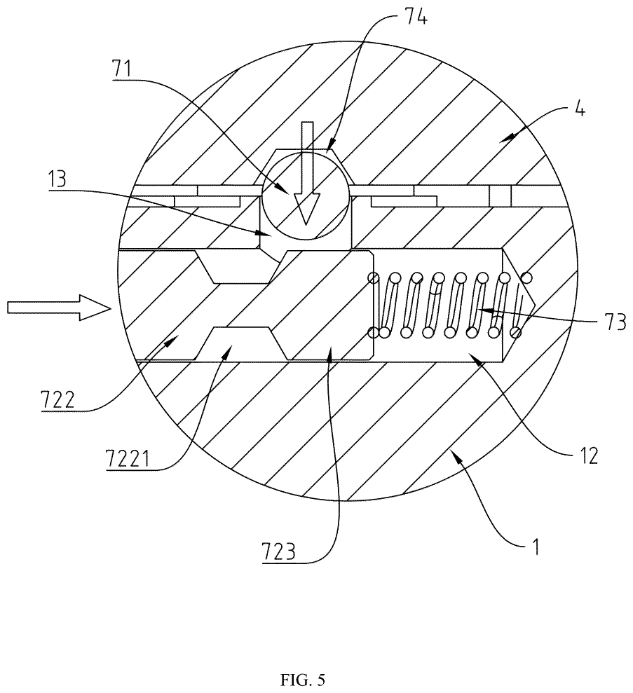

As shown in FIG. 4 and FIG. 5, the first anti-misoperation devices 7 include first locking devices and first positioning grooves 74. The first locking devices are arranged on the valve bodies 1, the first positioning grooves 74 are formed in the handles 4, and when the handles 4 are rotated to be in a state where the ball valves are closed, the first locking devices can be clamped into the first positioning grooves 74 and limit the handles 4 to this position.

The first locking devices include first positioning beads 71, first positioning pins 72, and first reset members 73, the first positioning beads 71 can move back and forth along the valve bodies 1 in a vertical direction, the first positioning pins 72 are arranged between the first reset members 73 and the other ball valve, one ends of the first positioning pins extend out of the valve bodies 1, and the first positioning pins 72 can move back and forth along the ball valves in a horizontal direction. When the two ball valves are clamped, the first positioning pins 72 can move towards the first reset members 73 under the pushing of the other ball valve, and a direction of movement of the first positioning pins is shown by an arrow in FIG. 5. At this time, the first positioning pins 72 can provide a first receding space for the first positioning beads 71, the first positioning beads 71 move downwards under the action of gravity to be completely embedded into the valve bodies 1, and a direction of movement of the first positioning beads is shown by an arrow in FIG. 5. At this time, the first positioning beads 71 have no limiting effect on the handles 4, and the handles 4 may rotate. When the two ball valves are separated, due to the limitation of the limiting seats 6, the two ball valves can only be separated when being in the closed state. At this time, the first positioning pins 72 are away from the first reset members 73 under driving of the first reset members 73, and the first positioning pins 72 can push the first positioning beads 71 to move upwards and limit the part of the first positioning beads 71 in the first positioning grooves 74. Thus, the handles 4 are kept in the closed state of the ball valves.

After the two ball valves are clamped, the valve body 1 of one ball valve pushes the first positioning pin 72 of the other ball valve to move towards the first reset members 73, and the first positioning pin 72 moves to a position where the first receding space is provided for upward movement of the first positioning bead 71. At this time, the first positioning bead 71 is completely embedded in the valve seat and does not limit the handle 4. At this time, the valve with the dual ball valves is in a use state, and the handles 4 can be freely rotated. However, when the two ball valves are separated, the external force applied by the valve bodies 1 to the first positioning pins 72 is released, and the first positioning pins 72 are reset under the action of the reset members. At this time, the first positioning beads 71 move upwards under the pushing of the first positioning pins 72 and are clamped into the positioning grooves, so as to limit the handles 4 to a position where the ball valves are closed.

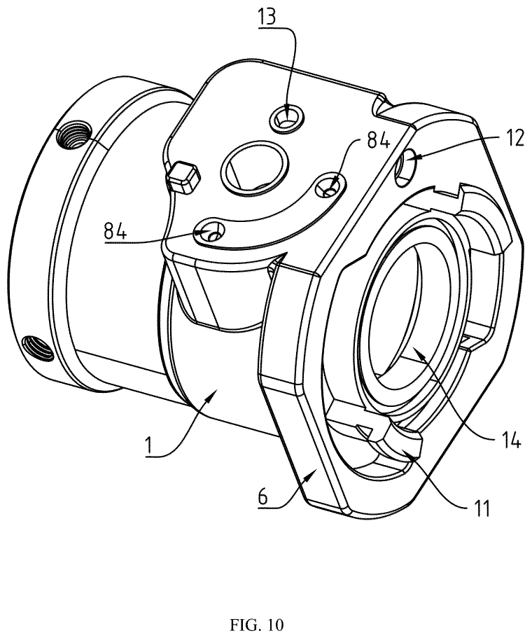

As shown in FIG. 10, first sliding grooves I 12 and second sliding grooves I 13 are formed in the valve bodies 1, the first sliding grooves I 12 and the second sliding grooves I 13 are formed perpendicularly and communicative with each other, one ends of the second sliding grooves I 13 are located in middle positions of the first sliding grooves I 12, and the first sliding grooves I 12 and the second sliding grooves I 13 form a T-shaped structure. The first sliding grooves are formed horizontally and are parallel to the flowing direction of the fluid, and the second sliding grooves are formed vertically and extend along the first sliding grooves towards one sides of the handles 4. The first positioning pins 72 slide in the first sliding grooves I 12, and the first positioning beads 71 slide in the second sliding grooves I 13. Widths of the second sliding grooves I 13 are greater than diameters of the first positioning beads 71, so that the first positioning beads 71 can slide in the second sliding grooves I 13. Moreover, depths of the second sliding grooves I 13 are smaller than the diameters of the first positioning beads 71, and in an initial state, the first positioning beads 71 partially protrude out of a sliding seat.

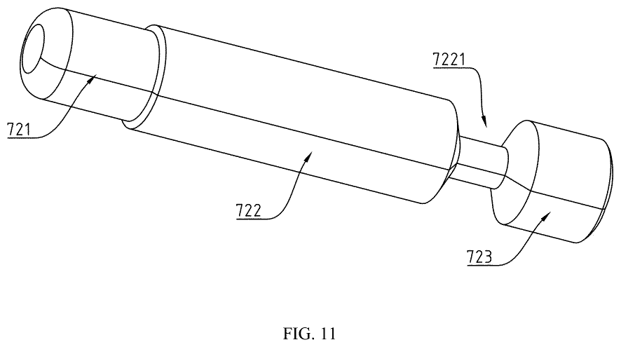

As shown in FIG. 11, each first positioning pin 72 includes a first pressing portion 721, a first receding portion 722, and a first limiting portion 723 which are connected in sequence, the first limiting portions 723 are connected to the first reset members 73, and one ends of the first pressing portions 721 extend out of the first sliding grooves I 12, that is, the first pressing portions 721 protrude out of the valve bodies 1. When the two ball valves are clamped, the valve bodies 1 apply external force to the first pressing portions 721 to push the first positioning pins 72 to move. After the external force is cancelled, the first reset members 73 push the first positioning pins 72 to reset.

Shapes of the first limiting portions 723 match shapes of the first sliding grooves I 12, and when the first limiting portions 723 move to be under the second sliding grooves I 13, the first limiting portions 723 close a connection of the second sliding grooves I and the first sliding grooves I, and the first positioning beads 71 can only be in the second sliding grooves I 13. At this time, due to heights of the second sliding grooves I 13 being smaller than the diameters of the first positioning beads 71, a part of the first positioning beads 71 inevitably protrudes out of the second sliding grooves I 13, that is, protrude out of the valve bodies 1.

First receding grooves 7221 are formed in outer walls of the first receding portions 722, and when the first receding grooves 7221 move to be under the second sliding grooves I 13, the first receding grooves 7221 communicate with the second sliding grooves I 13 and define a first receding space with the first sliding grooves I 12. That is, the depths of the second sliding grooves I 13 are extended, and a sum of the depths of the second sliding grooves I 13 and the first receding space is greater than the diameters of the first positioning beads 71, so as to ensure that the first positioning beads 71 can be completely embedded into the valve bodies 1. At this time, positioning of the handles 4 is released and the position of the handles 4 can be adjusted at any time.

In one embodiment, the first receding grooves 7221 are first annular grooves formed along outer walls of the first receding portions 722 in a circumferential direction. Because cross sections of the first sliding grooves I 12 are circular, the first positioning pins 72 also adopt a rod-shaped structure. The first annular grooves of an annular structure may ensure that even if the first positioning pins 72 rotate during movement, the first annular grooves can always move to be over the second sliding grooves I 13.

In one embodiment, openings of the first receding grooves 7221 are of a flaring structure, and when the first positioning pins 72 are reset, the first positioning beads 71 can slide along an inclined surface of the flaring structure of the first receding grooves 7221, thereby reducing hard contact between the first positioning beads 71 and the first positioning pins 72, and prolonging the service life of the first positioning beads 71 and the first positioning pins 72.

The first anti-misoperation devices 7 ensure that the handles 4 can be rotated freely only when the two ball valves are in a clamped state. When two ball valves are separated, that is, one end of a single ball valve is a free end and no pipeline is connected, at this time, the first anti-misoperation devices 7 limit the handles 4 to be in a state where the ball valves are closed. To open the ball valves, additional acting force must be additionally applied to the first positioning pins 72, thereby reducing misoperation on the ball valves when the ball valves are not properly connected.

In one embodiment, as shown in FIG. 2, the ball valves are further provided with second anti-misoperation devices 8, and the second anti-misoperation devices 8 are arranged on the ball valves and can lock the ball valves in both fully open and fully closed states. The second anti-misoperation devices 8 include second locking devices arranged on the handles 4 of the ball valves, and the second locking devices can move synchronously with the handles 4. The valve bodies 1 are provided with second positioning grooves 84 formed corresponding to the second locking devices, and the two second positioning grooves 84 are provided and are located in first and second positions respectively. When the second locking devices move to the first position or above the second position, the second locking devices can be clamped into the second positioning grooves 84 in the corresponding positions, and at this time, the ball valves are in the fully open or fully closed state.

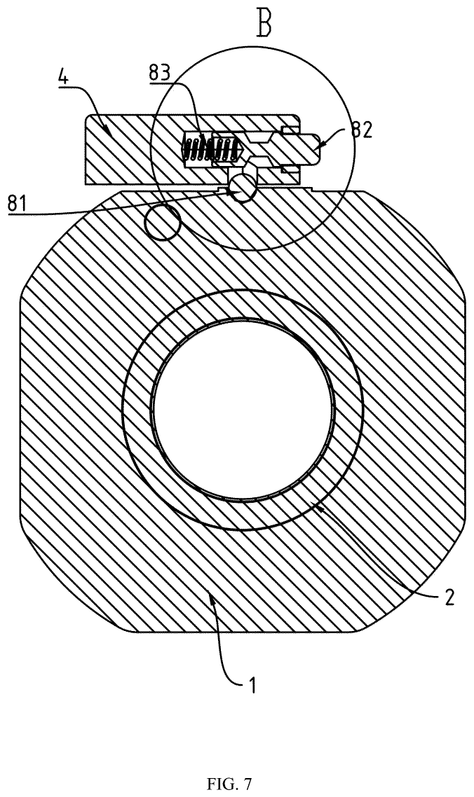

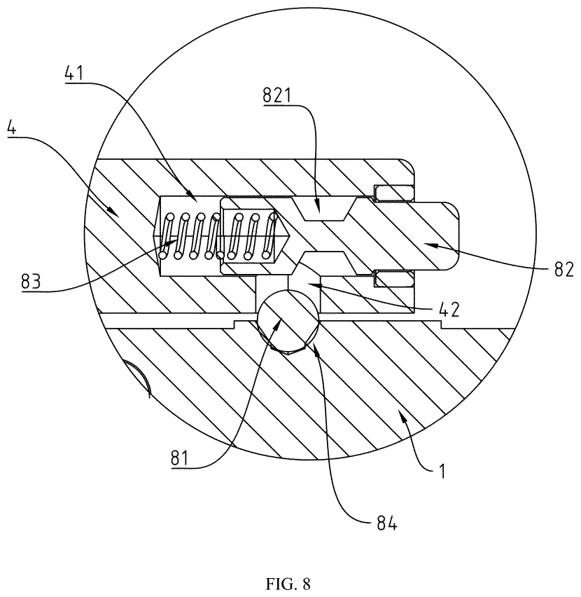

As shown in FIG. 7 and FIG. 8, the second locking devices include unlocking assemblies that move synchronously with the handles 4, and second positioning beads 81, and the second positioning beads 81 can move back and forth along the handles 4 in the vertical direction. The unlocking assemblies include second positioning pins 82 that can move along the handles 4 in the horizontal direction, and second reset members 83 that push the second positioning pins 82 to reset. The second positioning pins 82 can approach the second reset members 83 under pushing of the external force, and at this time, the second positioning pins 82 can provide a second receding space for upward movement of the second positioning beads 81. When the second positioning pins 82 are away from the second reset members 83 under driving of the second reset members 83, the second positioning pins 82 can push the second positioning beads 81 to move downwards and limit a part of the second positioning beads 81 in the second positioning grooves 84.

When the handles 4 are rotated, the second positioning pins 82 must be pushed through the external force, so as to overcome thrust provided by the second reset members 83, and make the second positioning pins 82 move to a position where the receding space for the upward movement of the second positioning beads 81 is provided. At this time, the handles 4 are pushed again, and the second positioning grooves 84 can be utilized to move the second positioning beads 81 upwards and to slide out of the second positioning grooves 84, thus unlocking the handles 4. When the second locking devices reach the second positioning grooves 84 at the first position and the second position, the second positioning pins 82 are released by the external force, the second positioning pins 82 are reset under driving of the second reset members 83, at this time, the second positioning beads 81 move downwards under gravity and pushing of the second positioning pins 82 and are partially clamped into the second positioning grooves 84, and the second positioning pins 82 return to an initial position and limit the upward movement of the second positioning beads 81, thus locking the handles 4. Both the unlocking assemblies and the second positioning beads 81 move synchronously with the handles 4 and are arranged on the handles 4 without loss. Moreover, unlocking can be completed only by pushing the second positioning pins 82 with the external force, thereby avoiding misoperation on the ball valves caused by a false touch on the handles 4, and further improving using safety of the ball valves.

In one embodiment, the depths of the second positioning grooves 84 are smaller than radiuses of the second positioning beads 81, and only a small part of the second positioning beads 81 can be located in the second positioning grooves 84, that is, the part of the second positioning beads 81 embedded in the second positioning grooves 84 is less than half of the second positioning beads 81. Such depths of the second positioning grooves 84 can ensure that the second positioning beads 81 are pushed out of the second positioning grooves 84 in the rotation process of the handles 4.

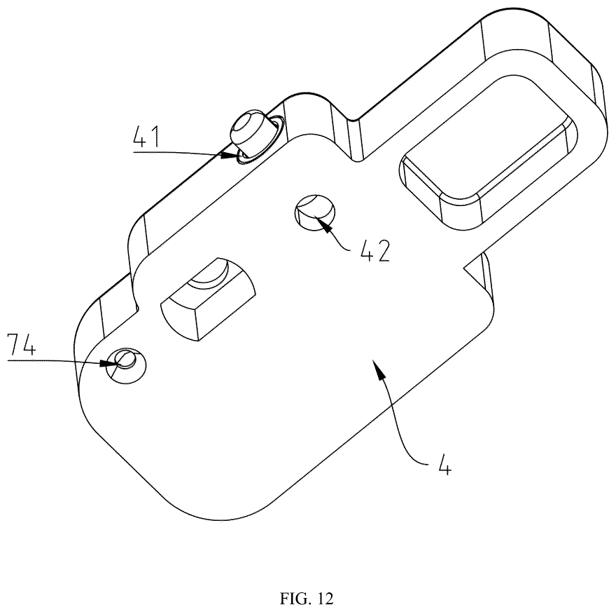

As shown in FIG. 12, first sliding grooves II 41 and second sliding grooves II 42 are formed in the handles 4, the first sliding grooves II 41 and the second sliding grooves II 42 are formed perpendicularly and communicate with each other, one ends of the second sliding grooves II 42 are located in middle positions of the first sliding grooves II 41, and the first sliding grooves II 41 and the second sliding grooves II 42 form a T-shaped structure. The first sliding grooves II 41 are horizontally formed, and the second sliding grooves II 42 are perpendicularly formed. The second positioning pins 82 slide in the first sliding grooves II 41, the second positioning beads 81 slide in the second sliding grooves II 42, widths of the second sliding grooves II 42 are greater than diameters of the second positioning beads 81, and heights of the second sliding grooves 42 are smaller than the diameters of the second positioning beads 81.

As shown in FIG. 8, the second positioning pins 82 have the same structure as the first positioning pins 72, each second positioning pin includes a second pressing portion, a second receding portion, and a second limiting portion which are connected in sequence, the second limiting portions are connected to the second reset members 83, and one ends of the second pressing portions extend out of the first sliding grooves II 41. The external force is pressed on the second pressing portions to push the second positioning pins 82 to move. After the external force is cancelled, the second reset members 83 are connected with the second limiting portions to push the second positioning pins 82 to reset.

Shapes of the second limiting portions match shapes of the first sliding grooves II 41, and when the second limiting portions move to be over the second sliding grooves II 42, the second limiting portions close a connection of the second sliding grooves II 42 and the first sliding grooves II 41, and the second positioning beads 81 can only be in the second sliding grooves II 42. At this time, due to heights of the second sliding grooves II 42 being smaller than the diameters of the second positioning beads 81, a part of the second positioning beads 81 inevitably protrudes out of the second sliding grooves II 42, that is, protrude out of the handles 4.

Second receding grooves 821 are formed in outer walls of the second receding portions, and when the second receding grooves 821 move to be over the second sliding grooves II 42, the second receding grooves 821 communicate with the second sliding grooves II 42 and define a second receding space with the first sliding grooves II 41. That is, the heights of the second sliding grooves II 42 are extended, and a sum of the heights of the second sliding grooves II 42 and the second receding space is greater than the diameters of the second positioning beads 81, so as to ensure that the second positioning beads 81 can be fully embedded into the handles 4. At this time, the handles 4 are rotated through the external force, and the second positioning grooves 84 can push the second positioning beads 81 to move upward and slide out of the second positioning grooves 84, so as to release fixation between the second positioning beads 81 and the second positioning grooves 84, that is, release positioning of the handles 4.

In one embodiment, the receding grooves are annular grooves formed along outer walls of the receding portions in a circumferential direction. Because cross sections of the first sliding grooves are circular, the positioning pins also adopt a rod-shaped structure. The annular grooves may ensure that even if the positioning pins rotate during movement, the annular grooves can always move to be over the second sliding grooves.

In one embodiment, openings of the second receding grooves 821 are of a flaring structure, when the second positioning pins 82 are reset, the second positioning beads 81 can slide along an inclined surface of the flaring structure of the second receding grooves 821, thereby reducing hard contact between the second positioning beads 81 and the second positioning pins 82, and prolonging the service life of the second positioning beads 81 and the second positioning pins 82.

In one embodiment, openings of the second positioning grooves 84 are also of a flaring structure. When the second positioning beads 81 move synchronously with the handles 4, the second positioning beads 81 can slide along an inclined surface of the flaring structure of the second positioning grooves 84, so as to provide guidance for the upward movement of the second positioning beads 81 and avoid hard contact between the second positioning grooves 84 and the second positioning beads 81.

In one embodiment, both the first reset members 73 and the second reset members 83 adopt springs, and the springs are embedded in the first sliding grooves I 12 and the first sliding grooves II 41. One ends of the springs abut against bottoms of the first sliding grooves I 12 or the first sliding grooves II 41, and the other ends of the springs abut against the first positioning pins 72 or the second positioning pins 82.

In one embodiment, in order to improve stability of spring positioning, fixing grooves for allowing end parts of one ends of the corresponding springs to be embedded are formed in the first limiting portions 723 and the second limiting portions.

When the springs are in an initial state, the springs can push the first positioning pins 72 or the second positioning pins 82 to move towards one side away from the springs. At this time, the first limiting portions 723 are located under the second sliding grooves I 13, the second limiting portions are located under the second sliding grooves II 42, and the springs are in a compressed or natural state. When the first positioning pins 72 or the second positioning pins 82 are pushed by the external force to move, the springs are continuously compressed until the first receding grooves 7221 are located under the second sliding grooves I 13, and the second receding grooves are located above the second sliding grooves II 42. Throughout the entire process, as long as the external force is cancelled, the springs push the first positioning pins 72 and the second positioning pins 82 to reset under elastic force of the springs.

In the present disclosure, the limiting seats 6 of the polygonal structure are used to avoid fluid leakage caused by the rotation and disassembly of the two ball valves in a clamped and open state. Meanwhile, in cooperation with the first anti-misoperation devices 7 and the second anti-misoperation devices 8, the first anti-misoperation devices 7 ensure that when the two ball valves are separated, the handles 4 are limited to be in the state where the ball valves are closed, and the second anti-misoperation devices 8 ensure that the handles 4 can only be rotated when the external force is applied to the handles, and the positions of the handles 4 are adjusted. The combination of the three greatly reduces the misoperation of the valve with the dual ball valves and improves the safety of the valve with the dual ball valves.

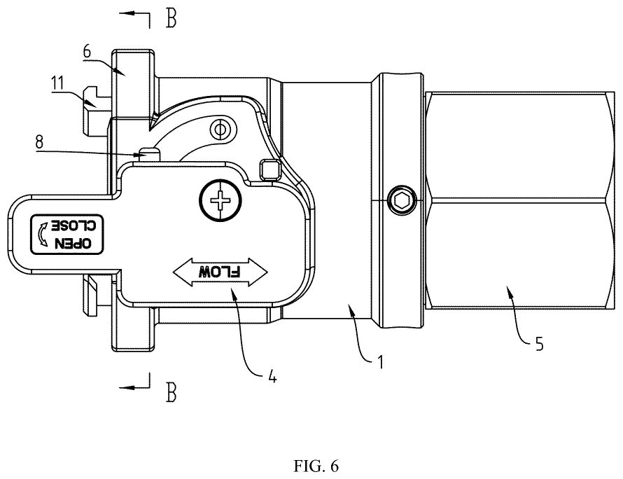

At the beginning, the two ball valves are in a separation device, and the state of the ball valves is shown in FIG. 6. At this time, the first limiting portions 723 of the first positioning pins 72 press the first positioning beads 71 upwards in the first limiting grooves, and the handles 4 are perpendicular to the fluid channels 14. After the two ball valves are clamped, the first positioning pins 72 always extrude the first reset members 73 under extrusion of the corresponding valve bodies 1. At this time, the first receding grooves 7221 remain in a state of communicating with the second sliding grooves II 42, and the first positioning beads 71 move downwards to release the limiting on the handles 4. The second positioning pins 82 are pressed, then the handles 4 are rotated to make the second positioning beads 81 slide out of one second limiting groove (the ball valves are in the closed state) until the second positioning beads 81 move into another second limiting groove (the ball valves are in the open state), the second positioning pins 82 are released, and the second positioning beads 81 are embedded into the second limiting grooves at this position under the pushing of the second positioning pins 82 and remain stationary. At this time, the handles 4 are parallel to the fluid channels 14, the two ball valves are both in the open state to allow the fluid to pass through. At this time, the valve with the dual ball valves is shown in FIG. 1. The limiting seats 6 use the polygonal structure, due to the limitation of the handles 4, the two ball valves cannot rotate therebetween, thereby avoiding separation of the ball valves in the open state of any ball valve and effectively reducing fluid leakage. When the pipeline needs to be disassembled for maintenance, the external force is required to press the second positioning pins 82, and then the handles 4 are rotated, so that the handles 4 of the two ball valves are rotated to be in the state where the ball valves are closed. At this time, the handles 4 release the limiting on the rotation of the ball valves, and the ball valves can be rotated and disassembled.

In one embodiment, in order to improve the stability of rotation of the ball bodies, guiding assemblies located in the valve bodies 1 are further arranged at one ends of the ball bodies 2 away from the valve rods 3. The guiding assemblies guide the rotation of the ball bodies 2.

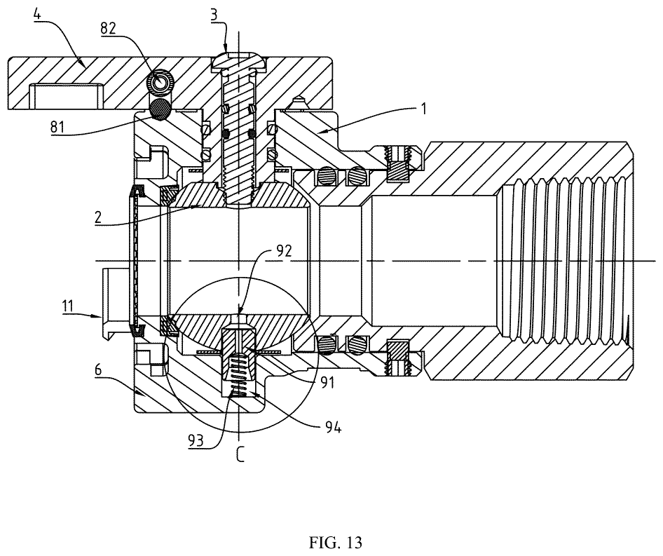

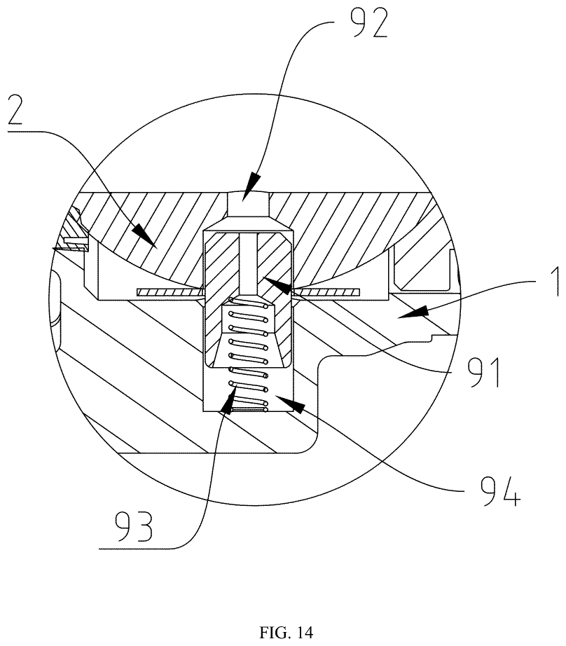

As shown in FIG. 13 and FIG. 14, the guiding assemblies include guiding rods 91, the guiding rods 91 are coaxially arranged with the valve rods 3, that is, axes of the guiding rods 91 are perpendicular to the axes of the ball bodies 2, the guiding rods 91 can upwards extend into the ball bodies 2, and guiding grooves 92 for allowing the guiding rods 91 to be inserted are formed in the ball bodies 2. The valve rods 3 and the guiding rods 91 respectively provide support points for the rotation of the ball bodies 2 from two sides of the ball bodies 2, thereby improving the stability of the rotation of the ball bodies 2.

Because the ball bodies 2 are stable in the rotation process and cannot deviate, the sealing performance of the entire ball valves is improved, and liquid leakage between the ball bodies and the valve bodies is reduced. Therefore, at this time, only sealing rings abutting against the ball bodies 2 are arranged on one sides of the valve bodies 1 close to a water outlet.

In order to facilitate assembly of the ball bodies, the guiding rod 91 can move up and down along the its own axes. That is, when the ball bodies 2 enter the valve bodies 1, the guiding rods 91 can be pushed to move downwards to make receding for the entry of the ball bodies 2. When the ball bodies 2 reach the position, the guiding rods 91 can extend into the guiding grooves 92 under driving of third reset members 93. The guiding rods 91 in a form of ascending and descending facilitate the assembly of the ball bodies 2 while satisfying the rotation guidance of the ball bodies 2.

The third reset members 93 are springs, and placement grooves 94 for allowing the springs to be embedded are formed in the valve bodies 1. At the same time, the guiding rod 91 can also be completely embedded into the placement grooves 94 when moving downwards, thus avoiding interference with the entry of the ball bodies 2. The placement grooves 94 provide a placement space for the third reset members 93 on one hand, guide the movement of the guiding rods 91 on the other hand, and meanwhile, provide the receding space for the guiding rods 91. Embedding grooves for allowing the springs to be embedded are further formed in the guiding rods 91, one ends of the springs abut against bottoms of the placement grooves 94, and the other ends of the springs abut against bottoms of the embedding grooves. Openings of the placement grooves 94 are provided with cushion blocks able to abut against the ball bodies, thereby improving the sealing performance and preventing the liquid from leaking between the two.

The above implementations are only intended to illustrate the technical concept and characteristics of the present disclosure, are intended to enable those familiar with the technology understand the content of the present disclosure and implement it, and cannot limit the scope of protection of the present disclosure hereby. Any equivalent changes or modifications made according to the spirit essence of the present disclosure should be covered in the scope of the protection of the present disclosure.

What is claimed is:

1. A valve with dual ball valves, comprising the two ball valves arranged side by side and clamped with each other, wherein each ball valve comprises a valve body, a ball body, a valve rod and a handle, clamping structures are respectively and correspondingly arranged on one surfaces of the two valve bodies abutting against each other, and each ball valve further comprises:
a limiting seat, wherein the limiting seat is arranged at one end of the valve body provided with the clamping structure, the limiting seat extends outward along an outer wall of the valve body, the limiting seat is of a polygonal structure, and when the two valve bodies are clamped, the two limiting seats abut against each other, and projection surfaces of the two limiting seats in a flowing direction of fluid overlap; when the ball valves are in an open state, the handle is located on one side of one edge of the limiting seat of the ball valve and extends to the same side of a corresponding edge of the limiting seat of the other ball valve, and the handle limits rotation of the two limiting seats; and
a first anti-misoperation device, wherein the first anti-misoperation device is able to lock one ball valve in a closed state when one ball valve is separated from the other ball valve, the first anti-misoperation device comprises a first locking device and a first positioning groove, the first locking device is arranged on the valve body, the first positioning groove is formed in the handle, and when the handle rotates to be in a state where the ball valve is closed, the first locking device is able to be clamped into the first positioning groove.

2. The valve with the dual ball valves according to claim 1, wherein when the ball valves are in the open state, a distance between the handles and the limiting seats in a vertical direction is less than 5 mm.

3. The valve with the dual ball valves according to claim 1, wherein the polygonal structure is a quadrangle, and chamfers are arranged between two adjacent edges of the quadrangle.

4. The valve with the dual ball valves according to claim 1, wherein a rotation angle of the handle is 90°, when the handle rotates to a position where a length direction is parallel to the flowing direction of the fluid, the ball valve is open, a projection of the handle in a direction perpendicular to the flowing direction of the fluid partially overlaps with one edge of the limiting seat of the other ball valve; and when the handle rotates to a position where the length direction is perpendicular to the flowing direction of the fluid, the ball valve is closed, and the projection of the handle in the direction perpendicular to the flowing direction of the fluid is separated from the limiting seat of one ball valve.

5. The valve with the dual ball valves according to claim 1, wherein the first locking devices comprise first positioning beads, first positioning pins, and first reset members, the first positioning beads are able to move back and forth along the valve bodies in a vertical direction, one ends of the first positioning pins extend out of the valve bodies, and the first positioning pins are able to move back and forth along the ball valves in a horizontal direction; and
when the ball valves are clamped, the first positioning pins are able to approach the first reset members under pushing of the other ball valve, and at this time, the first positioning pins are able to provide a receding space for falling of the first positioning beads; and when the ball valves are separated, the first positioning pins are away from the first reset members under driving of the first reset members, the first positioning pins are able to push the first positioning beads to move upwards and limit a part of the first positioning beads in the first positioning grooves.

6. The valve with the dual ball valves according to claim 5, wherein first sliding grooves I for allowing the first positioning pins to slide and second sliding grooves I for allowing the first positioning beads to slide are formed in the valve bodies, the first sliding grooves I and the second sliding grooves I are formed perpendicularly and communicate with each other, one ends of the second sliding grooves I are located in middle positions of the first sliding grooves I, and depths of the second sliding grooves I are smaller than diameters of the first positioning beads.

7. The valve with the dual ball valves according to claim 6, wherein each first positioning pin comprises a first pressing portion, a first receding portion, and a first limiting portion which are connected in sequence, the first limiting portions are connected to the first reset members, and one ends of the first pressing portions extend out of the first sliding grooves I; and
shapes of the first limiting portions match shapes of the first sliding grooves I, and when the first limiting portions move to be under the second sliding grooves I, the first limiting portions close a connection of the second sliding grooves I and the first sliding grooves I; and first receding grooves are formed in outer walls of the first receding portions, and when the first receding grooves move to be under the second sliding grooves I, the first receding grooves communicate with the second sliding grooves I and define a first receding space with the first sliding grooves I.

8. The valve with the dual ball valves according to claim 7, wherein the first receding grooves are first annular grooves formed along outer walls of the receding portions in a circumferential direction, and openings of the first receding grooves are of a flaring structure.

9. The valve with the dual ball valves according to claim 1, wherein the ball valves further comprise second anti-misoperation devices, the second anti-misoperation devices are able to lock open and closed states of the ball valves, the second anti-misoperation devices comprise second locking devices and second positioning grooves, the second locking devices are arranged on the handles and are able to move synchronously with the handles, the second positioning grooves correspond to the locking devices and are arranged on the valve bodies, two second positioning grooves are provided, and the two second positioning grooves respectively correspond to the open and closed states of the ball valves.

10. The valve with the dual ball valves according to claim 9, wherein the second locking devices comprise second positioning beads, second positioning pins, and second reset members, the second positioning beads are able to move back and forth along the handles in a vertical direction, the second positioning pins are able to move along the handles in a horizontal direction and reset under pushing of the second reset members, the second positioning pins are able to approach the second reset members under pushing of external force, at this time, the second positioning pins are able to provide a second receding space for upward movement of the second positioning beads, and when the second positioning pins are away from the second reset members under driving of the second reset members, the second positioning pins are able to push the second positioning beads to move downwards and limit a part of the second positioning beads in the second positioning grooves.

11. The valve with the dual ball valves according to claim 1, wherein guiding assemblies located inside the valve bodies are further arranged at one ends of the ball bodies away from the valve rods; and
the guiding assemblies comprise guiding rods, the guiding rods are coaxially arranged with the valve rods and are able to move up and down along axes of the guiding rods, guiding grooves arranged corresponding to the guiding rods are formed in the ball valves, and the guiding rods are able to extend into the guiding grooves under driving of third reset members.
